(19) United States
(12) Patent Application Publication
(10) Pub. No.: US 2008/0255890 A1
(43) Pub. Date: Oct. 16, 2008

(54) TICKETING SYSTEM

(76) Inventor: Peter D. Hilliard, Schomberg (CA)

Correspondence Address: KRUGLIAK, WILKINS, GRIFFITHS & DOUGHERTY CO, LPA, 4775 MUNSON STREET N.W., P.O. BOX 36963, CANTON, OH, 44735-6963, US

(21) Appl. No.: 12/103,071

(22) Filed: Apr. 15, 2008

Related U.S. Application Data
(60) Provisional application No. 60/912,021, filed on Apr. 16, 2007.

(51) Int. Cl. G06Q 30/00; G06Q 10/00

(52) U.S. Cl. 705/5; 705/26

(57) ABSTRACT

A ticketing system is disclosed and comprises a computing facility. The facility is operable to (i) receive an order, for goods and/or services of a provider, transmitted to the facility by a remote input device; (ii) ascertain if the goods and/or services ordered are available from the provider in sufficient quantities to permit the order to be filled; (iii) transmit to the remote input device, if goods and/or services availability has been ascertained to be insufficient to fill the order, a notification as to non-availability; and (iv) if goods and/or services availability has been ascertained to be sufficient to fill the order, satisfy the order.

### CROSS-REFERENCE TO RELATED APPLICATION

This application claims the benefit of U.S. Provisional Patent Application Ser. No. 60/912,021 filed Apr. 16, 2007.

### FIELD OF THE INVENTION

The present invention relates to the field of ticketing.

### BACKGROUND OF THE INVENTION

Computerized ticketing was first popularized in the late 1970s and early 1980 by Ticket Reservation Systems, Inc., which operated a series of computerized terminals under the TICKETRON™ banner that it called “electronic box offices”. These were located in publicly accessible locations, such as banks and department stores, and securely linked to a sophisticated central private computer system that maintained an electronic “inventory” of the tickets made available to the TICKETRON system by venue operators and the like. Ticketmaster, LLC, a competitor, absorbed TICKETRON in 1991, and the merged entity remains the world's largest seller of event tickets. However, with the advent of the Internet, the network of ticket outlets has mostly vanished, and a large proportion of event tickets are now sold over the Internet to end consumers. For events, which are typically booked well in advance, this system can work well. However, ticketing is also carried out in association with items which are purchased by users on an impromptu basis, shortly before being needed, for example, tickets for a bus trip or for entry to a theme park. In these cases, users may not have access to an Internet-linked computer, such that this sales model has limitations. In these cases, ticketing in many instances is still done via the venerable “box office” model, which is limiting in terms of sales.

### SUMMARY OF THE INVENTION

A ticketing system forms one aspect of the invention. The ticketing system comprises a computing facility. The computing facility is operable to receive an order, for goods and/or services of a provider, transmitted to the facility by a remote input device; ascertain if the goods and/or services ordered are available from the provider in sufficient quantities to permit the order to be filled; transmit to the remote input device, if goods and/or services availability has been ascertained to be insufficient to fill the order, a notification as to non-availability; and, if goods and/or services availability has been ascertained to be sufficient to fill the order, satisfy the order.

The system permits limited-availability tickets to be sold from remote locations, via remote input devices. The mechanism by which data flows in use of the system is sufficiently efficient to permit the system to be deployed, for example, on debit or credit card readers as are commonly possessed by merchants. As a further example, the system can be deployed on wireless debit/credit card readers, as used by merchants at festivals and the like. Merchants can thus utilize ticket sales as a supplemental source of revenue, and enterprises can use merchants and others as agents for ticket sales, even in respect of limited-availability product that would conventionally be sold via a box office. The system can be flexible, to permit the enterprises to tailor the price and availability of product from agent to agent. This, for example, permits an enterprise to sell tickets at lower prices in economically depressed areas, or in areas where a given event or product has heavier competition in comparison to other areas. A vendor might also wish to reduce prices of a product in areas geographically remote from a ticketed event, to reflect the increased travel costs to the event that ticket purchasers in such areas would bear and encourage sales from such remote areas. The system also permits enterprises to reduce the amount of currency that might otherwise be received by ticket vendors/acceptors, for example, bus drivers, to simultaneously simplify the transaction for the bus driver and reduce the risk of theft. Yet further, the system also permits enterprises to substantially discount product in the period immediately preceding the scheduled completion of the event, to avoid unsold seats, etc.

Other advantages, features and characteristics of the present invention, as well as methods of operation and functions of the related elements, will become more apparent upon consideration of the following detailed description and the appended claims with reference to the accompanying drawings, the latter being briefly described hereinafter.

### DESCRIPTION OF THE DRAWINGS

FIG. 1 is a diagrammatic view of the system, in overview.

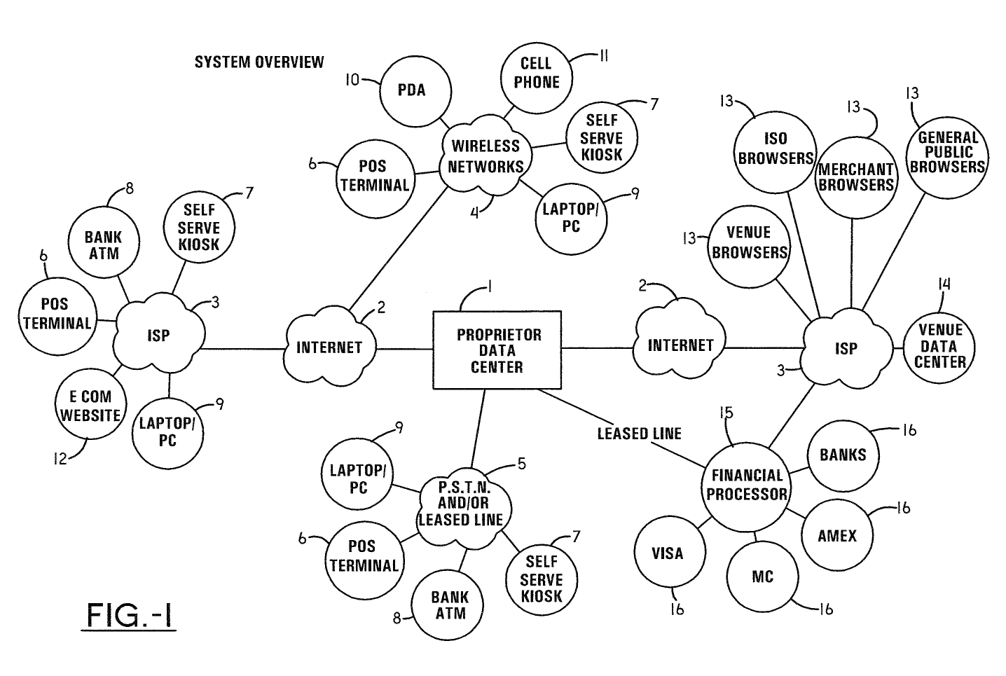

FIG. 2 is a diagrammatic view of a network with which the system interacts in use;

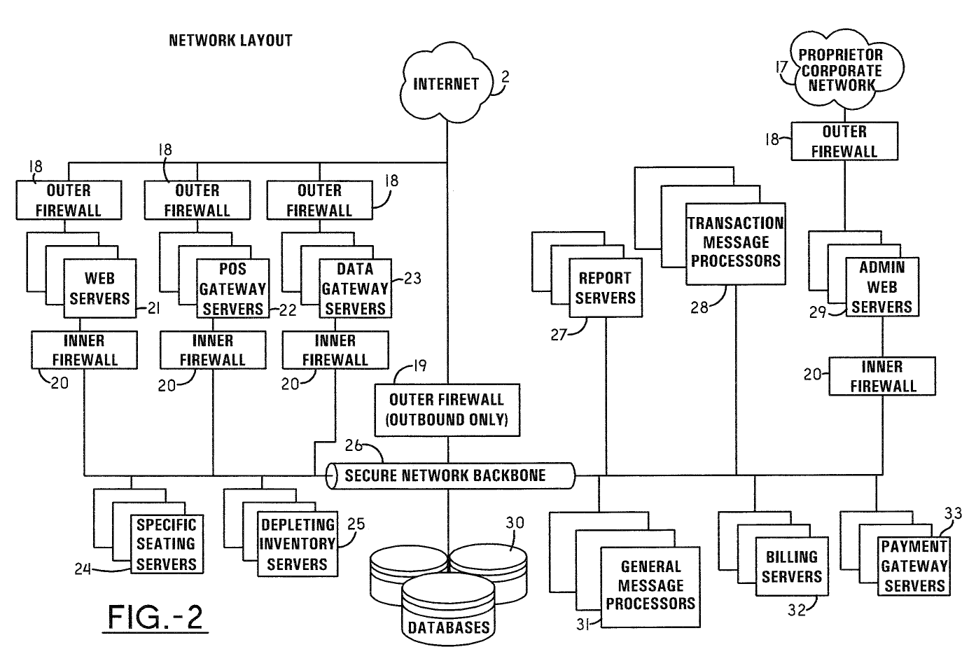

FIG. 3 is a diagrammatic view of the ticket purchase aspects of the system;

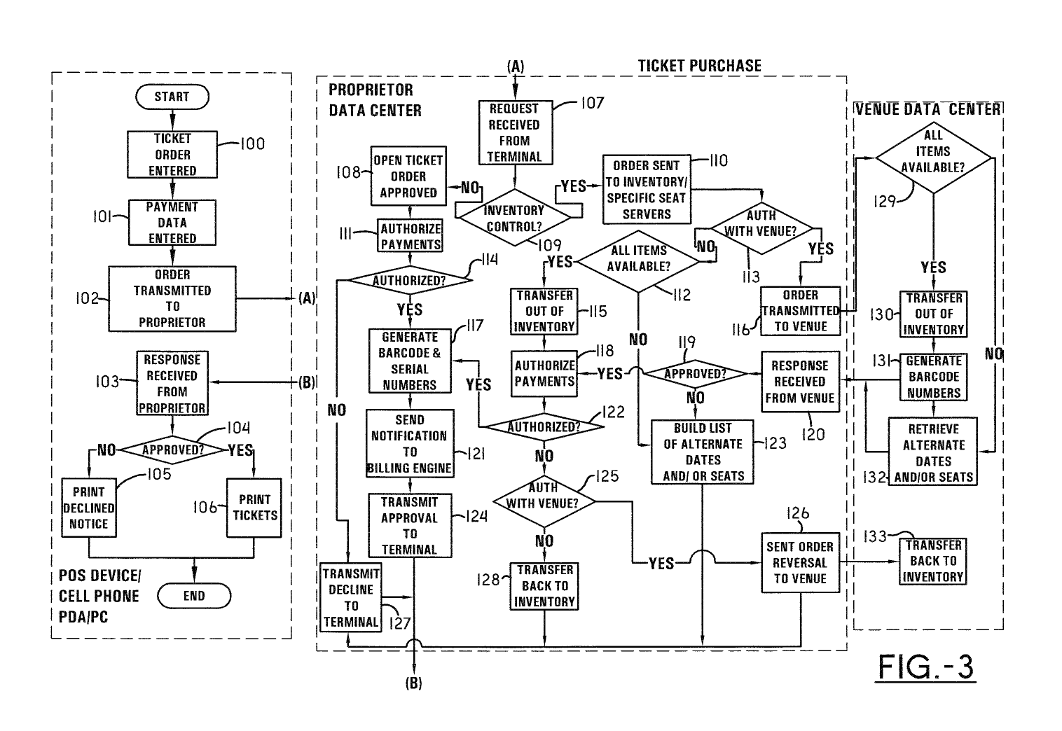

FIG. 4 is a diagrammatic view of the barcode generation aspects of the system;

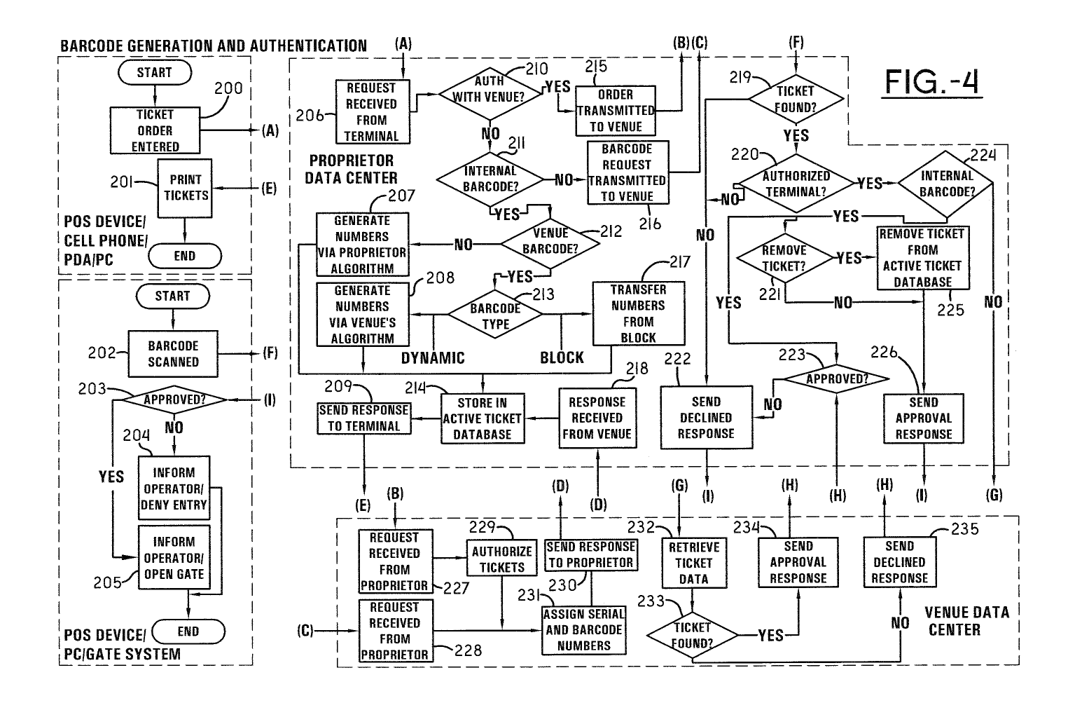

FIG. 5 is a diagrammatic view of the update management aspects of the system;

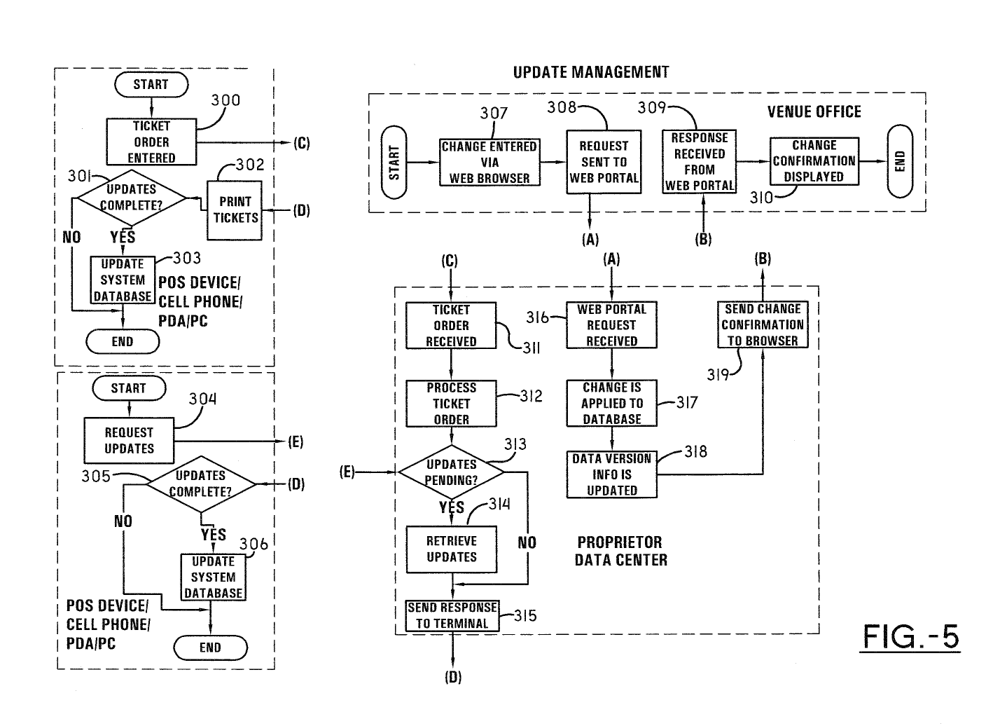

FIG. 6 is a diagrammatic view of the product management aspects of the system;

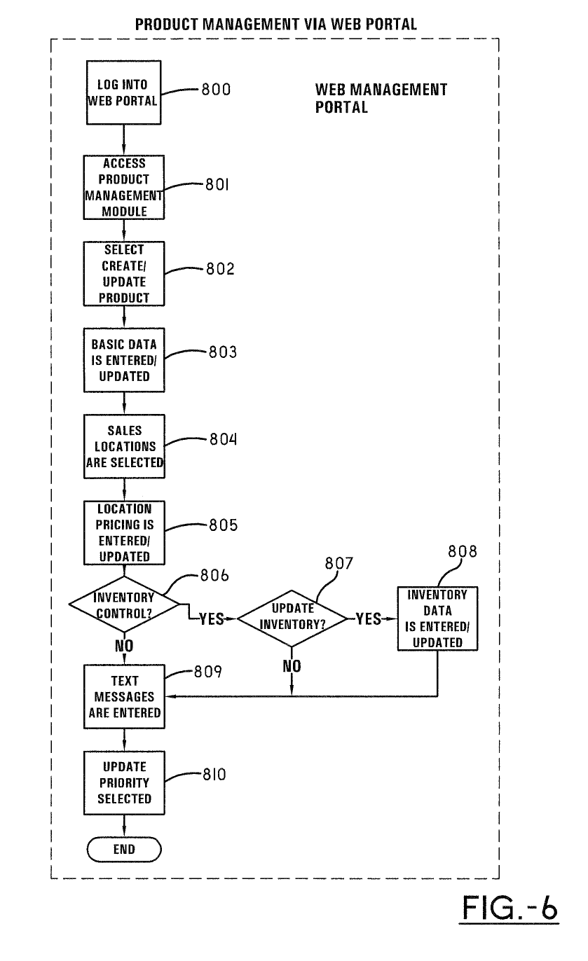

FIG. 7 is a diagrammatic view of the self service ticket purchase via PDA aspects of the system;

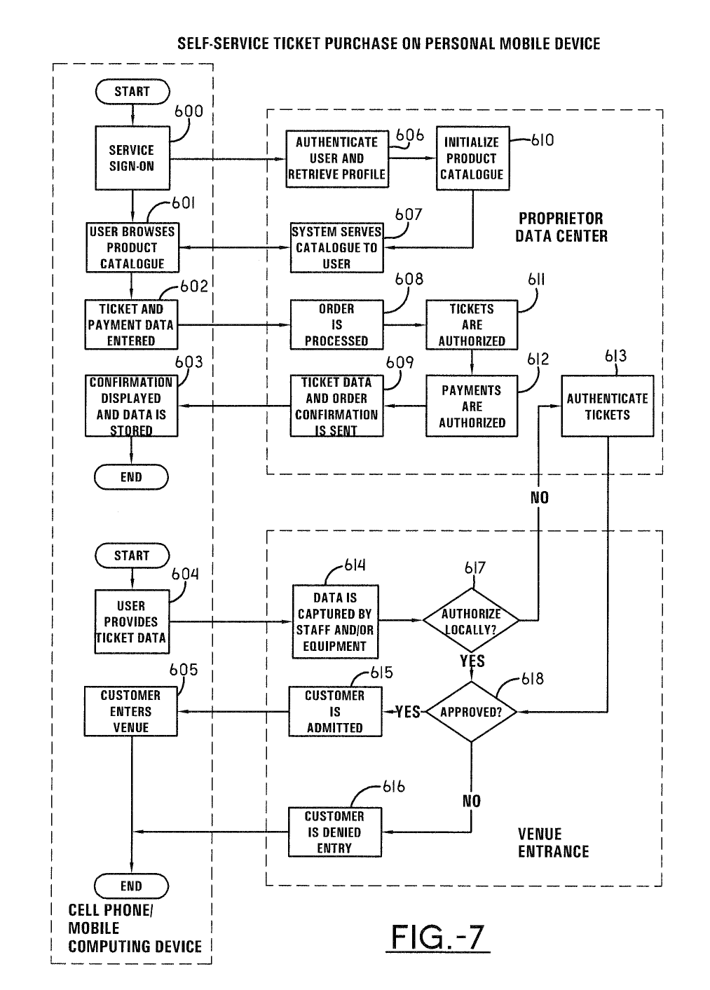

FIG. 8 is a diagrammatic view of the self service ticket purchase via room service aspects of the system;

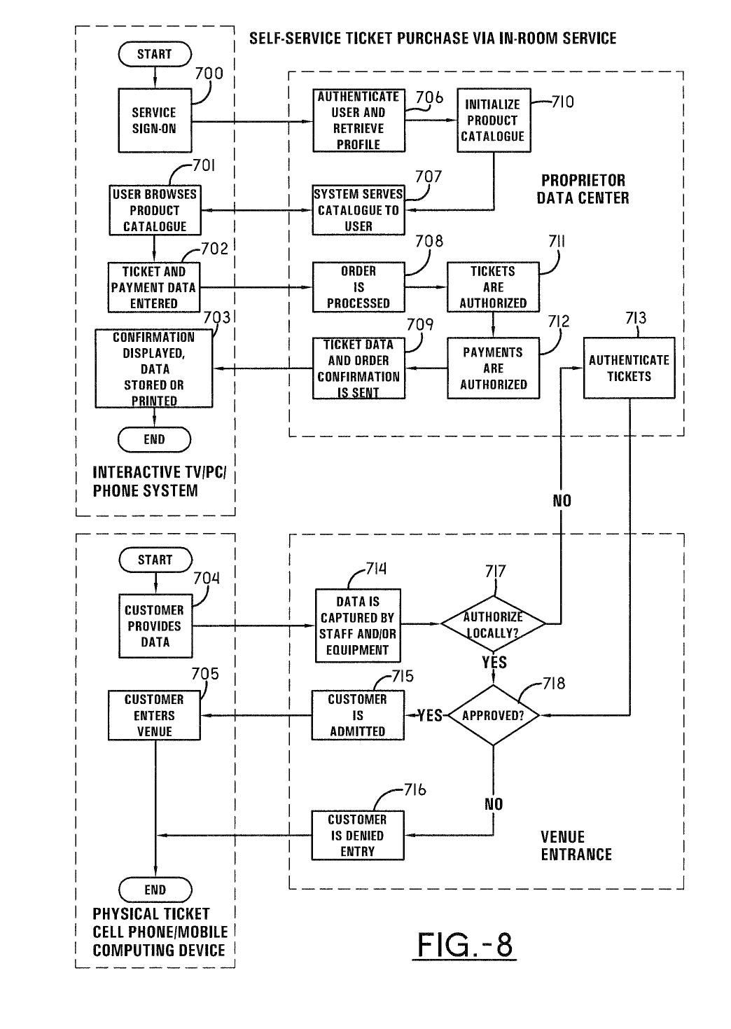

FIG. 9 is a diagrammatic view of the money flow aspects of the system; and

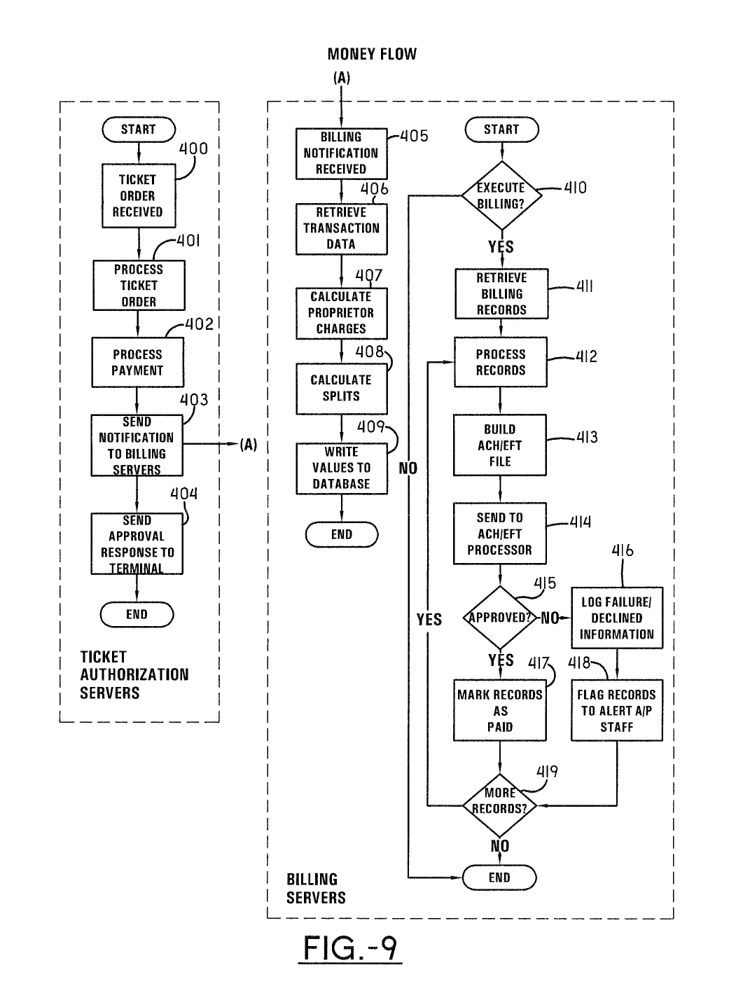

FIG. 10 is a diagrammatic view of the money flow aspects of the system.

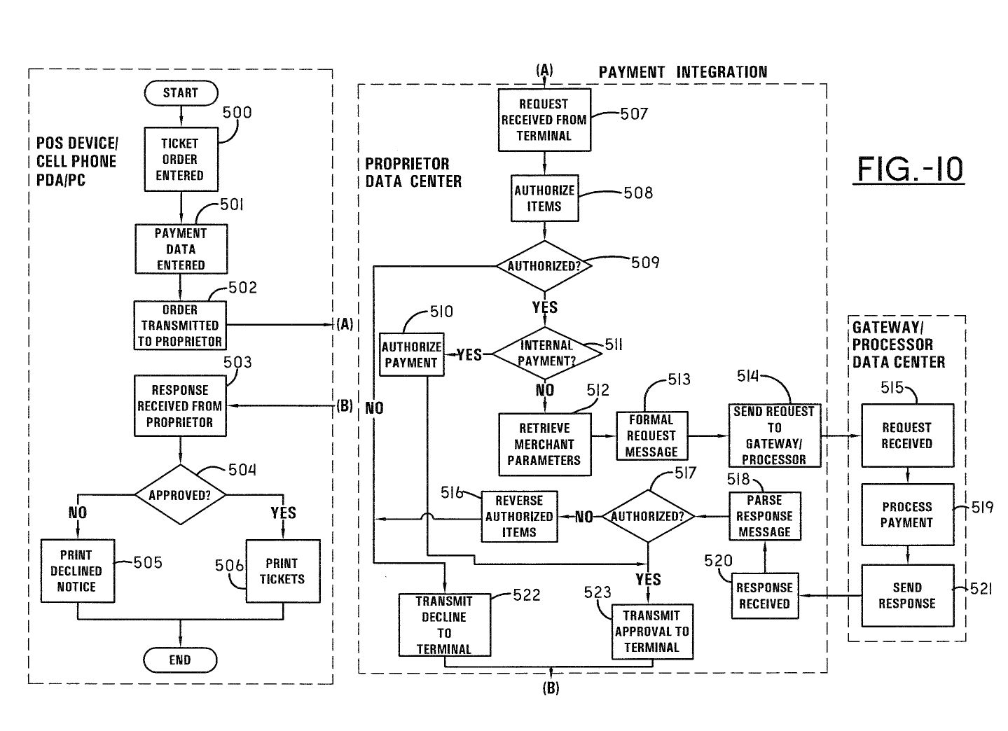

### DETAILED DESCRIPTION

A system according to a preferred embodiment of the present invention is hereinafter described in detail. In the preferred embodiment, the system is operated by an entity, denoted for simplicity throughout the description as “Proprietor”. The operator of the system, i.e. “Proprietor” may be the owner of the system, but it should be understood that the Proprietor may be a licensed user, hired manager, etc., and the word “Proprietor” should not be viewed as limiting in any way.

### System Overview

At the heart of the service is the Proprietor data centre 1 housing the servers, software, communications equipment and operations staff necessary to make the service available to customers and partners 24/7.

The centre is capable of handling transaction requests such as ticket purchases from a variety of input devices such as POS Terminals 6, Self-Serve Kiosks 7, Bank ATMs 8, Laptops/PCs (web browser or custom application) 9, PDAs 10, Cell Phones 11 and e-commerce websites 12. These various devices are all connected to the data centre through Wireless Networks 4, Public Switched Telephone Networks (PSTNs) 5 and the Internet 2.

Venues, merchants and sales partners are capable of managing their transaction accounts and terminals as well as generating reports through the use of a web browser 13 and the Proprietor Web portal 21. The general public may also connect via web browser 13 to the Proprietor web portal to purchase products online and/or to locate the nearest POS Terminals 6, Self-Serve Kiosks 7 and Bank ATMs 8 offering the service.

To insure a secure and fully integrated environment where tickets are not generated until payment has been fully authorized the Proprietor service is tied to banks 16 and major credit card issuers 16 via Financial Processors 15. The service is integrated with these institutions via Payment Gateway servers 33 that are responsible for managing the authorization of credit, debit, cheque and smart card transactions.

Venue data centers 14 can be connected via secure VPN (virtual private network) or private line to the Proprietor service for the purposes of product authorization (inventory, reservation and seating control) in real-time. The connection also allows the transmission of transactional data to the Venue in real-time for accounting, reporting and other business purposes.

### Network Layout

The Secure Network Backbone 26 consists of networking devices such as routers, switches and firewalls providing a high-speed, resilient and secure communications infrastructure for the servers and databases that provide and manage the Proprietor service to customers. The Outer Firewalls 18 separate the Proprietor network from the public Internet 2 and provide the first line of defense. The Inner Firewalls 20 provide an additional layer of security in the event the servers that precede them are compromised.

The Web Servers 21 perform various functions such as providing a web portal for customers and partners to manage their accounts, request reports as well as to provide e-commerce services direct to customer or “white labelled” by a partner organization. POS Gateway servers 22 are responsible for accepting requests from remote devices such as POS Terminals 6, Self-Serve Kiosks 7 and Bank ATMs 8, etc. Data Gateway servers 23 provide multiple functions such as providing an interface between Proprietor and Venue data centres 14 for the purposes of item purchase authorization for those items which are under inventory, seat and/or reservation control by the remote venue. They also allow for sales and transactional data to be exported from the Proprietor service in real-time to Venue and customer systems.

Transaction Message Processors 28 are responsible for coordinating the transaction process. They manage Inventory 25, Specific Seating 24, Payment Gateway 33 and external Venue 14 servers as necessary in order to fulfil the transaction request. Inventory 25 and Specific Seating 24 servers are concerned with managing an inventory of items and seats within a venue such as a theatre, auditorium, arena, etc.

Database servers 30 provide centralized storage of all data generated and required by the Proprietor service. General Message Processors 31 are responsible for handling services such as updating product databases in remote terminals and e-commerce sites, sending messages to terminals, etc. Report servers 27 accept requests from web-users and other systems to generate reports based on transactional and other data stored in the system Databases 30. Billing servers 32 track all billable events within the system, process and summarize the information for the purposes of generating invoices and reports as well as transferring monies between accounts via EFT (Electronic Funds Transfer)/ACH (Automated Clearing House).

Proprietor operations staff manage the system via the Administration Web servers 29.

### Ticket Purchase

A ticket order 100 is entered at a POS Terminal 6, Self-Serve Kiosk 7, Bank ATM 8, Laptop/PC (web browser or custom application) 9, PDA 10, Cell Phone 11 or an e-commerce website 12 by selecting one or more items from a menu of available products. The payment data is entered 101 and the order is transmitted 102 to the Proprietor data centre 1 via wireless networks 4, the Internet 2, or the Public Switched Telephone Network (PSTN) 5. The ticket order is received 107 at the Proprietor data centre 1 via Web server 21, POS Gateway server 22 or Data Gateway server 23 depending on the device used to originate the order. The request is analyzed to determine if the items being requested are under inventory control 109. If the items are not under inventory control, the items are automatically authorized 108 and processing moves onto payment authorization 111. If however the items are under inventory control the order is sent to the Inventory/Specific Seating servers 110 where they are analyzed to determine if authorization requires transmission to an external Venue server 113. If the items require external authorization they are transmitted 116 to the Venue's data centre 14. The Venue's server determines if the item is available for purchase 129, if it is the item is pulled out of inventory 130. If the item is not available, the system will attempt to retrieve a list of alternate dates (if applicable) 132. A response is received from the Venue's data centre 120 and checked to see if the order was approved 121. If the order was approved processing continues with payment authorization 118. If the order was declined the system will build a list of alternate dates 123 if received from the venue and transmit the decline to the terminal 127. If the items do not require external Venue processing the system checks it's internal Inventory/Specific Seating servers for item availability 112. If available, the items are transferred out of inventory 115 and processing continues with payment authorization 118; otherwise the system will build a list of alternate dates/seats 123 if applicable and transmit the decline to the terminal 127.

The system attempts to obtain payment authorization (cash, credit, debit etc) 111. For all payment types not requiring external authorization (cash, voucher, etc) the system automatically issues an approval, for all other types (credit, debit, cheque, etc) the system forwards the request to the Payment Gateway servers 33 to obtain authorization from an external payment processor and/or financial institution. The system checks the result of the authorization process 114, and if approved, a notification is sent to the Billing Engine 121 and the approval is transmitted to the terminal 124. If declined and the server determines the item(s) were authorized by an external Venue server 125 a reversal is sent to the Venue 126 to return the item(s) back to inventory 133. The item(s) will be returned back to inventory if authorized by internal servers 128. In both cases a declined response is then sent back to the terminal 127.

The terminal receives a response from the Proprietor data centre 103 and checks if the request was approved 104. For approved responses the system will generate receipts and tickets 106. For declined responses the system will generate one or more receipts but will not generate tickets 105. For devices equipped with a printer such as POS Terminals 6, Self-Serve Kiosk 7, Bank ATM 8, Laptop/PC (web browser or custom application) 9 and e-commerce website 12 (via customer's PC) tickets and receipts will be printed. For devices such as a PDA 10 or Cell Phone 11 an electronic ticket will be transmitted to the device.

### Barcode Generation & Authentication

A ticket order 200 is entered at a POS Terminal 6, Self-Serve Kiosk 7, Bank ATM 8, Laptop/PC (web browser or custom application) 9, PDA 10, Cell Phone 11 or an e-commerce website 12 by selecting one or more items from a menu of available products and the order is transmitted to the Proprietor data centre 1 via wireless networks 4, the Internet 2, or the Public Switched Telephone Network (PSTN) 5. The ticket order is received 206 at the Proprietor data centre 1 via Web server 21, POS Gateway server 22 or Data Gateway server 23 depending on the device used to originate the order. The request is analyzed 210 to determine if the items being requested need to be authorized externally. If the items require external authorization they are transmitted 215 to the Venue's data centre 14. The authorization request is received by the Venue 227 and is then authorized 229 by the Venue's servers. If successfully authorized the Venue assigns serial #'s and or barcode numbers 231 if applicable for the requested items. The order response is then sent to Proprietor 230. When the order response is received 218 the active ticket information (serial # and/or barcode #) is stored 214 and a response is sent to the terminal 209.

If after analyzing the items 210 the system determines they are to be authorized internally the system then checks to see if the barcode is generated internally or by the Venue 211. If the barcode is generated by the Venue the request is sent 216, received by the Venue 228, serial and/or barcode numbers are generated 231, the response is sent to 230 and received by Proprietor 218. The active ticket information (serial # and/or barcode #) is stored 214 and a response is sent to the terminal 209. If the barcode is generated internally the system checks to see which coding scheme 212 is assigned to the item(s). If the coding scheme is Proprietor specific, Proprietor algorithms are applied to generate the numbers 207. If the coding scheme is Venue specific the system checks the type of barcode 213 type to apply. If it is assigned from a block 217 the number(s) are extracted from a block of numbers previously received from the Venue; if the numbers are generated dynamically a Venue provided algorithm 208 is used to generate the number(s). Whichever internal method is used, the numbers are then stored in the active ticket database 214 and the response is sent to the terminal 209.

After receiving the response 201 the terminal prints the tickets 201 if the request was authorized. Any serial #'s and/or barcode #'s generated by Proprietor and/or the Venue are printed on their respective tickets.

Tickets are authenticated by scanning the barcode 202 and transmitting the value to the Proprietor data centre 1 via wireless networks 4, the Internet 2, or the Public Switched Telephone Network (PSTN) 5. The code is received at the Proprietor data centre 1 via Web server 21, POS Gateway server 22 or Data Gateway server 23 depending on the device used to originate the request. A search is performed 219 to retrieve the ticket information and based on the result of the search the system returns a decline 222 if the ticket is not found or it proceeds to terminal authorization 220 if it is found. Terminal authorization determines if the terminal that transmitted the barcode is allowed to accept this code or if it must reject it. If the terminal is not authorized to accept this code the system returns a decline 222 otherwise it analyzes the code to determine if the code was internally generated 224. If the code is externally generated it is transmitted to the Venue's data centre 14 for authorization. The ticket information is searched 232 and based on the result 233 the ticket's information is returned with an approval status 234 if found, otherwise a decline is returned 235.

The Proprietor server analyzes the Venue's response 223 and if the response is a decline, a decline response is sent to the terminal 222. If the response is an approval or the barcode check 224 indicated the code was internally generated the system then checks if the ticket information is to be removed 221 from the active ticket database. Tickets can have configurable lifetimes, for example: a ticket may remain active until it is used a predefined amount of times or it may remain active until an expiry date and/or time is reached. If the ticket is no longer valid it is removed from the active ticket database 225 and the approval response is returned 226, otherwise only the approval response is returned 226 and the ticket is left in the database.

When the response is received, its approval status is checked 203. If approved the operator is informed and/or the gate is opened allowing the ticket-holder entry. If however, a decline was received the operator is informed and/or the gate remains closed barring the ticket-holder entry.

### Update Management

A customer (i.e. Venue or merchant) may update their database (products, terminal agents, etc) via the Proprietor web portal servers 21. The changes are input 307 via web browser 13 and the request is sent to the Proprietor web portal 308. The request received by the web portal 316 located in the Proprietor data centre 1 is processed and stored in the customer's database 317. The version information used to synchronize the remote devices with the Proprietor servers is updated 318 to reflect that a change to the data has been made. A confirmation of the change is sent to the browser 319 that issued the change request. The response is received from the web portal 309 and displayed in the customer's web browser 310.

A remote device can receive updates in the following ways:
1) The terminal operator requests a manual refresh of the database via the terminal's menu system.
2) The terminal calls automatically at its daily scheduled time to perform an update.
3) The user who initiated the change via the web portal can flag those changes as requiring immediate application on the terminal in which case the terminal is signalled to perform an update when it next performs a transaction.
4) The terminal receives the updates in a “trickle” fashion as it performs transactions throughout the day.

Once a transaction has been completed, scenario 3 follows the same procedure as scenarios 1 and 2. The procedure for these scenarios is as follows: The terminal sends an update request 304 to the Proprietor data centre 1 and the system determines if any updates are pending 313 for this terminal. If updates are pending they are retrieved 314 from the database and transmitted 315 to the terminal, otherwise the system transmits 315 a signal to the terminal indicating it is up-to-date. After receiving the data the terminal determines whether it has received all the data successfully 305 and if it has, the updates are applied to it's internal database 306. Otherwise the terminal retains what updates it received and contacts Proprietor again to obtain the remaining updates 304 and follows the same procedure until successful or until it exhausts it's allowed retry attempts.

The procedure for scenario 4 is as follows: A ticket order 300 is sent to the Proprietor data centre 1 and after receiving the order 311, it is processed 312. Whether the order is approved or declined the system will check for pending updates 313 and retrieve a small portion 314 of the data to return to the terminal 315 along with the order authorization response. If no changes are pending only the order's authorization response is returned. The amount of update data pending for a terminal can be quite large so in order to not delay the transaction request only a small portion is sent with each transaction. As the terminal receives each transaction response and any pending changes it checks to see if all updates have been received 305 and if this is true it updates it's internal database 306. If transmission of pending updates has not yet completed the terminal will wait until it's next transaction to receive more data or alternatively the remaining updates may be received if scenarios 1, 2 or 3 occur.

### Product Management via Web Portal

The web portal system allows merchants (tour operators, venues, attractions, etc) to manage their product catalogue from a centralized location via a web browser 13 enabled device. The product data entered/updated on the system is then made available to various devices such as: POS Terminal 6, Self-Serve Kiosk 7, Bank ATM 8, Laptop/PC (web browser or custom application) 9, PDA 10, Cell Phone 11, e-commerce website 12, Interactive Television 34 and Interactive Telephone 35.

The user (merchant) begins the management session by logging into 800 the web management portal hosted on web servers 21 at the Proprietor data center 1. The product management module is selected 801 presenting the user with an interface screen providing methods to create, update, delete, search for, view and report on products within the catalogue. The catalogue may be private containing only the products the user wishes to sell on devices under his/her control (POS Terminal 6, Self-Serve Kiosk 7, etc). The catalogue may also be global, containing products from multiple vendors available to many devices (POS Terminal 6, Self-Serve Kiosk 7, Cell Phone 11, etc) where most if not all devices are not under control of the user. In the global catalogue, a user is only allowed to manage products created by himself/herself.

The user selects the create/update 802 feature to begin creating/editing product information. If the user selects “create”, a blank form containing fields (text boxes, check boxes, lists, etc) to allow the building of a new product is displayed. If “update” is selected the form will display with the data currently defined for the chosen product. Once displayed, the user can enter/modify basic data 803 such as the product name, product lookup codes, product category, discounts and printing options such as: printing a ticket, barcode, custom text, disclaimer, etc.

The location (physical street address) of devices and systems such as: POS Terminal 6, Self-Serve Kiosk 7, etc are recorded in the Proprietor system when they are assigned access to the network. These locations are then grouped into regions such as city district, city, state/province, country and continent. Personal mobile devices such as: Cell Phone 11, PDA 10, etc transmit their physical location as mentioned in other parts of this document. The transmitting at the time of transaction of this location is used to assign the device to the region groupings previously mentioned. In the case of e-commerce websites the location of the customer utilizing the website is determined by the IP (Internet Protocol) address assigned to the customer's Laptop/PC 9. Again, as with the Cell Phone 11 and PDA 10, this location is then used to assign the customer to a region.

The system allows a user to control in which locations and/or regions the product is available for sale 804. The administrator of the global product catalogue assigns on a per user basis which regions the user is allowed to offer product within. Any device(s) and/or system(s) located outside of the region(s) defined by the user will not have access to the product. Any requests received by the Proprietor system from a device or system not authorized to sell the product (outside an authorized region) will be declined by the system. When entering pricing for the product 805 the user has the option to assign one price for all locations/regions or to tailor the price for as many locations/regions as desired.

If the product is under inventory control 806 the user has the option to update inventory information 807. When updating inventory information 808 the user will be presented with a series of forms that allows for setting the available quantity (seats, widgets, etc) for tours, events, line runs, flights, product lines, etc. If the item is not under inventory control or the user chooses not to modify inventory data the system provides the option to issue text messages 809 to supported devices. The message could convey that special sale pricing is now in effect, provide instructions to agents selling the product and/or advertisements to the end customer. In the case where messages would be potentially sent to devices not under the control of the user, the operator of such devices could choose to configure their account not to accept messages.

As mentioned in the “Update Management” sections of this document, the software supports different modes of pulling updates from the Proprietor servers. When entering product data the user has the option to select the update priority mode 810. The user can choose to force the update immediately the next time a device connects to the system, to allow the terminal to pull the changes at it's next scheduled call in time (once daily) and various other degrees of priority in between. As with messaging, the user can only perform this function on devices under his/her control or on those devices for which their operators allow this action.

### Self-Service Ticket Purchase on Personal Mobile Device

The system provides a series of interfaces to allow customers at any time and from any location to use their cell phones 11, mobile palm top computers 10, PDAs (personal digital assistants) 10, laptops 9 and other devices capable of interacting with the Proprietor service. The customer can interact with the service via the device's built-in web browser or an application provided by Proprietor and downloaded to the device where possible.

The user (customer) begins by activating the Proprietor application (where applicable) or by utilizing the device's built-in web browser and accessing a public website address. During the sign-on process the user has the option of logging on with an account or as a guest user. Users with accounts will be able to take advantage of various promotional offers made available from time to time.

The user begins the process by signing on to the service 600 with an optional username, password and geographical location. The geographical location is determined in order of preference by Global Positioning System (where available), Cell Network Triangulation (where available), Cell Tower ID (where available), a series of user prompts that narrow the user's location to a country, state/province and city. The Sign-on request is sent to Proprietor and authenticated 606. If the user provided an account (username & password) the profile for this account is retrieved, otherwise the user is logged in as a guest. The system initializes the product catalogue 610 and tailors the initial list of items based on user preferences from the profile and the geographical location (if supplied). The system transmits a portion of the catalogue 607 to the user allowing he/she to browse it 601 on the mobile device as well as specify search criteria to filter unwanted items. The user continues browsing 601 and the system continues serving the requests 607 until the user has completed selecting the product(s)/service(s) or the user quits.

Once all products have been selected the user is required to enter their payment data 602. Payment can be made via credit card entry on the device either manually via the keyboard or electronically where applicable. The user also has the option of having the item(s) billed to the wireless account associated with the device.

The order is received by the Proprietor servers for processing 608: the tickets are authorized 611, payments are authorized 612 and the ticket data such as barcodes, serial numbers, confirmation numbers, etc are transmitted to the device 609. The mobile device receives the data and displays the result to the user as well as stores any applicable data (barcodes, serial numbers, etc) 603.

The user upon arriving at the venue is required to present proof of purchase 604 to gain entry to the venue. The type of data (proof) provided depends on the capability of the device and capabilities of staff and/or equipment at the venue. The forms of data presented to the venue can be but are not limited to:
Barcode displayed on the device's screen.
Wireless transmission via short/medium range technology: Wi-Fi, Bluetooth, RFID, contactless smartcard, etc. Or long range communication via GPRS, CDMA, etc.
Device phone number.
Customer credit card (used as identification for transaction).
Confirmation number provided during purchase.

The data is captured 614 by venue staff and/or equipment and the system determines 617 if the items are authorized locally or remotely by Proprietor servers. If remote authorization is required, the request is sent to and processed by Proprietor 613. If authorized 618 the customer is granted access 615 and enters the venue 605. Otherwise the user is denied entry 616.

### Self-Service Ticket Purchase via In-Room Service

The service is for use by hotels, motels, resorts, cruise ships and other similar locations. Access to the service is made accessible to the user in-room via a device capable of interfacing to the system. Examples include, but are not limited to: interactive television 34 (i.e. as is currently available to select movies, videogames), interactive phone 35, in-room computer 9, personal laptop 9, etc.

The user begins the process by signing on to the service 700 with an optional username and password.

The username and password provides the user with an account through which promotional offers are made available from time to time and it allows the system to be tailored to the user's preferences. If the user does not have an account he/she is logged in as a guest. This does not include the added benefits of an account but still allows product to be purchased. The geographical location is determined by street address where the location is fixed (i.e. hotel), by Global Positioning System where the location is mobile (i.e. cruise ship) and/or by a series of user prompts that narrow the user's location to a country, state/province and city. The Sign-on request is sent to Proprietor and authenticated 706. If the user provided an account (username & password) the profile for this account is retrieved, otherwise the user is logged in as a guest. The system initializes the product catalogue 710 and tailors the initial list of items based on user preferences from the profile and the geographical location (if supplied). The system transmits a portion of the catalogue 707 to the user allowing he/she to browse it 701 as well as specify search criteria to filter unwanted items. The user continues browsing 701 and the system continues serving the requests 707 until the user has completed selecting the product(s)/service(s) or the user quits.

Once all products have been selected the user is required to enter their payment data 702. Payment can be made via credit or debit card entry on the device either manually via the keyboard/screen or electronically where applicable. The user also has the option of having the item(s) billed directly to the room. The order is received by the Proprietor servers for processing 708: the tickets are authorized 711, payments are authorized 712 and the ticket data such as barcodes, serial numbers, confirmation numbers, etc are transmitted to the device 709.

The data is received from the Proprietor servers 703. Depending on the capabilities of the system at the customer's location any of the following will occur with the confirmation data:
Tickets are printed in the room where a printing device is provided.
Tickets are printed in a central location and are either delivered by staff to the customer's room or they are kept for customer pickup (i.e. a mailbox for the room, hotel front desk, etc).
Systems with printers (such as kiosks, computers, etc) are provided in a central location where the customer can logon to have the tickets printed immediately.
The Proprietor servers transmit the ticket data to a mobile device (cell phone, PDA, etc) specified by the customer during the sale process.
The system displays a confirmation number to the user at purchase time to be given to the venue staff in exchange for tickets/admission to venue.
The tickets are tied to the customer's credit card for identification purposes. The credit card is presented at the venue as authorization for tickets/admission to the venue.

The user upon arriving at the venue is required to present proof of purchase 704 to gain entry to the venue. The forms of data presented to the venue can be but are not limited to:
Printed ticket.
Confirmation number verbally given by customer.
Customer's credit-card
If the customer had the proof of purchase sent to a mobile device then the following are also possible where supported:
   Barcode displayed on the device's screen
   Wireless transmission via short/medium range technology such as: Wi-Fi, Bluetooth, RFID, contact-less smart card, etc. Or long range communication technology such as: GPRS, CDMA, etc.
   Device's phone number.

The data is captured 714 by venue staff and/or equipment and the system determines 717 if the items are authorized locally or remotely by Proprietor servers. If remote authorization is required, the request is sent to and processed by Proprietor 713. If authorized 718 the customer is granted access 715 and enters the venue 705. Otherwise the user is denied entry 716.

### Money Flow

A ticket order is received 400 at a server responsible for ticket authorization (i.e. web server 21, POS gateway server 22 or a Data gateway server 23) in the Proprietor data centre 1. The ticket order is processed 401 followed by the authorization of payment(s) 402 and if the order and payment are approved a notification of this transaction is sent 403 to the billing servers 32. The approval response is transmitted 404 to the terminal that originated the order. Credit and debit transactions that are authorized result in money transferred from the customer's account to a merchant account.

The transaction notification is received by a billing server 405 and the transaction data is retrieved 406 from the transaction database. Charges imposed by Proprietor for processing the transaction are calculated 407 and extracted from the total amount brought in by the transaction. Any splits that may be pending for the transaction for partners such as: Venue, Merchant, ISO, Processor/Bank, etc are calculated 408 and extracted from the remaining amount. All calculated values are written to the billing database 409 for further processing and reporting.

The Billing servers 32 periodically scan the billing database to determine if any transactions that have been successfully processed require funds to be transferred from a merchant account to other accounts (for example Proprietor's account to cover processing fees). If transactions are found the billing records are retrieved 411 and processed 412 to assign the account numbers involved for each billing record and to group if possible common records to reduce the costs incurred by electronic fund transfers. The processed data is then transformed via a data file building algorithm to produce an ACH (Automated Clearing House) or EFT (Electronic Funds Transfer) file 413 and this file is transmitted to a Bank 16 or Processor 15 for processing at which point the funds are all transferred to their respective accounts.

A response file is received from the Bank 16 or Processor 15 indicating the success or failure of each transfer request. The system checks each request to determine if it was approved 415. Any transfer that was approved is marked as paid 417. Any transfer that was declined is logged 416 and flagged for analysis by accounting staff 418. After all responses have been handled the system checks for any remaining transactions that require processing 419. If more are found they are processed 412, otherwise the system goes idle.

### Payment Integration

A ticket order 500 is entered at a POS Terminal 6, Self-Serve Kiosk 7, Bank ATM 8, Laptop/PC (web browser or custom application) 9, PDA 10, Cell Phone 11 or an e-commerce website 12 by selecting one or more items from a menu of available products. The payment data is entered 501 and the order is transmitted 502 to the Proprietor data centre 1 via wireless networks 4, the Internet 2, or the Public Switched Telephone Network (PSTN) 5. The ticket order is received 507 at the Proprietor data centre 1 via Web server 21, POS Gateway server 22 or Data Gateway server 23 depending on the device used to originate the order.

Any items or tickets received with the request are submitted for authorization 508, the authorization status is checked 509 and if authorized proceeds to payment authorization. If the items/tickets were not authorized a declined is transmitted to the terminal 522.

The system determines if the payment types received are internal 511 such as cash or external such as credit, debit, etc. If internal, they are authorized 510 and an approval is transmitted to the terminal 523. If the payment types are external the system retrieves the necessary merchant information 512 required by the processor/gateway to complete the transaction. The data is transformed into the message format 513 required and transmitted to the processor/gateway 514. The request is received 515 and submitted for authorization 519 and the result is transmitted 521 to Proprietor.

The response is received 520 and the data is parsed (transformed) 518 out of the processor/gateway format. The message is analyzed to determine if payment(s) was authorized 517. If not, any authorized items are reversed (cancelled) 516 and a decline is transmitted to the terminal 522. If authorization was received an approval is transmitted to the terminal 523.

The terminal receives the response 503 from Proprietor and analyzes the response to determine if it was approved 504. If approved any required tickets are printed 506, otherwise a declined notice is printed 505.

Although but a single preferred embodiment of the system has been herein described, it should be understood that various modifications can be made thereto. Accordingly, the invention should be understood to be limited only by the accompanying claims, purposively construed.

Table of Entities

| Number | Entity Name | Description |
|---|---|---|
| 1 | Proprietor data center. | The facility housing the servers which provide the |
| | | Proprietor ticketing service to all remote devices and PCs. |
| 2 | Internet | A global network of networks and computers. |
| 3 | ISP | Internet Service Provider - A company specializing in |
| | | connecting clients to the global internet via dial-up, DSL, |
| | | cable, leased line and/or wireless networks. |
| 4 | Wireless Networks | Local, wide area and global networks providing |
| | | communications through the air such as: GPRS, Mobitex, |
| | | Datatac, WiFi, Bluetooth and CDPD. Future wireless |
| | | networks will be supported when available. |
| 5 | P.S.T.N | Public Switched Telephone Network - The phone network |
| | | service provided to all homes and businesses. |
| 6 | POS Terminal | A Point-Of-Sale terminal capable of being loaded with |
| | | custom application software to access the Proprietor |
| | | service, accepting payments, printing tickets and receipts. |
| 7 | Self-Serve Kiosk | A device having the same capabilities as a Point-Of-Sale |
| | | terminal, however it is designed to be rugged and used by |
| | | the end customer without a merchant/agent in attendance. |
| | | The software in the device is designed to guide the |
| | | customer through the transaction process and optionally |
| | | provide promotional information about venues and |
| | | products through video and/or audio. |
| 8 | Bank ATM | An automated teller machine (automated banking |
| | | machine) capable of being loaded with custom application |
| | | software to access the Proprietor service, accepting |
| | | payments, printing tickets, receipts and guiding the |
| | | customer through the transaction process. Where possible |
| | | the system will also provide promotional information |
| | | about venues and products through video and/or audio. |
| 9 | Laptop/PC | A standard laptop or PC accessing the Proprietor service |
| | | over the web using a standard web browser or a custom |
| | | application. Where applicable, the laptop/PC will be |
| | | interfaced to necessary hardware to allow accepting credit, |
| | | debit and smartcard payments as well as printing a ticket. |
| 10 | PDA | Personal Data Assistant. A hand-held computing device |
| | | capable of accessing the Proprietor service over the web |
| | | using a standard web browser. Payments can be accepted |
| | | via credit card or where applicable charged to the |
| | | customers wireless phone/data account. |
| 11 | Cell Phone | A cell phone capable of accessing the Proprietor service |
| | | over the web using a standard web browser. Payments are |
| | | via credit card or charged to customer's wireless phone |
| | | account. |
| 12 | E-Com Website | An E-Commerce website hosted by Datarax Technologies |
| | | or a 3^{rd}-party site authorized by Proprietor technologies to |
| | | use and perform transactions with the Proprietor service. |
| | | The website(s) will be capable of accessing the product |
| | | catalogue on the Proprietor service, displaying information |
| | | and promotional material about the products and allow the |
| | | purchase of the products. |
| 13 | Web Browsers | The general public accessing the Proprietor web portal to |
| | | view the products available for purchase, the locations of |
| | | kiosks, Bank ATMs and merchants where the products can |
| | | be purchased or purchasing the products directly from the |
| | | web portal. |
| | | Partners such as ISOs, Venues and Merchants accessing |
| | | the Proprietor web portal to manage their accounts, |
| | | products and access transaction and business reports. |
| 14 | Venue Data Center | Where required the Proprietor service can be interfaced to |
| | | a Venue's data center to allow the Venue's existing |
| | | inventory and reservation infrastructure to authorize and |
| | | manage ticket sales as well as notify Proprietor |
| | | electronically when tickets are submitted via the ticket's |
| | | identification barcode. Where required, this interface can |
| | | be used to stream transactional data directly into the |
| | | Venue's accounting/financial systems. |
| 15 | Financial Processor | An organization providing the service of authorizing |
| | | credit, debit, check and smart-card transactions and |
| | | transferring the funds from the customer to the merchant's |
| | | bank account electronically. |
| 16 | Banks, Visa, MC, Amex | Financial institutions providing the credit, debit, cheque |
| | | and smart-card authorization networks utilized by |
| | | Financial Processors. |
| 17 | Proprietor Corporate | The internal Proprietor network used by it's employees to |
| | Network | access internal corporate resources, communicate and |
| | | access internet resources. |
| 18 | Outer Firewall | An application running on a server or a purpose specific |
| | | appliance designed to filter network traffic and provide |
| | | controlled access to the network resources it is tasked with |
| | | protecting. |
| | | The outer firewall sits between the Proprietor transaction |
| | | network and an external, possibly insecure and untrusted |
| | | network such as the internet. The firewall allows |
| | | connections both in-bound and out-bound as long as they |
| | | satisfy the firewall's security rules. |
| 19 | Outer Firewall | An application running on a server or a purpose specific |
| | (Outbound Only) | appliance designed to filter network traffic and provide |
| | | controlled access to the network resources it is tasked with |
| | | protecting. |
| | | The outer firewall sits between the Proprietor transaction |
| | | network and an external, possibly insecure and untrusted |
| | | network such as the internet. The firewall allows only out- |
| | | bound connections as long as they satisfy the firewall's |
| | | security rules. |
| 20 | Inner Firewall | An application running on a server or a purpose specific |
| | | appliance designed to filter network traffic and provide |
| | | controlled access to the network resources it is tasked with |
| | | protecting. |
| | | The inner firewall sits between the Proprietor transaction |
| | | network and the outer firewall. It is intended for additional |
| | | protection in the event that the outer firewall or the servers |
| | | in between the two firewalls are mis-configured or |
| | | compromised. |
| 21 | Web Servers | A cluster of web-servers providing the Proprietor web |
| | | portal and e-commerce capabilities to customers and |
| | | partners. |
| 22 | POS Gateway Servers | A cluster of servers that accept and manage connections |
| | | from non-web based devices such as point-of-sale |
| | | terminals, bank ATMs, Kiosks, etc. |
| 23 | Data Gateway Servers | A cluster of servers providing an interface between the |
| | | Proprietor network and a Venue's data center. For |
| | | example, these servers provide the following services: |
| | | interface to Venue's inventory/reservation systems, export |
| | | data to Venue's accounting/financial/reporting |
| | | applications, etc. |
| 24 | Specific Seating Servers | A cluster of servers providing the business logic necessary |
| | | to facilitate the selection and sale of seats in theatres, |
| | | stadiums, arenas, etc. The servers either manage the seats |
| | | within the Proprietor network or connect via the Data |
| | | Gateway Servers to a Venue's seat management system. |
| 25 | Depleting Inventory | A cluster of servers providing the business logic necessary |
| | Servers | to facilitate an inventory control system for tickets and |
| | | products. The servers either manage the products within |
| | | the Proprietor network or connect via the Data Gateway |
| | | Servers to a Venue's inventory control system. |
| 26 | Secure Network Backbone | A secured network within the Proprietor Data Center which |
| | | consists of redundant network paths, switches, routers, etc |
| | | to carry sensitive transactional information. |
| 27 | Report Servers | A cluster of servers providing business report generation |
| | | on a scheduled basis or on-demand via the web portal for |
| | | partner Venues, ISOs and Merchants. |
| 28 | Transaction Message | A cluster of servers providing the business logic necessary |
| | Processors | to manage the processing of transaction requests. These |
| | | servers interface with depleting inventory, specific seating |
| | | and payment gateway servers when necessary to complete |
| | | the transaction. |
| 29 | Admin Web Servers | A cluster of web servers providing administrative control |
| | | over the network and servers for use by the Proprietor |
| | | network operations team. |
| 30 | Databases | A cluster of database servers housing all the data |
| | | necessary to drive the Proprietor service and the data |
| | | captured during the process of authorizing transactions. |
| 31 | General Message Processors | A cluster of servers providing non-transactional services to |
| | | devices utilizing the Proprietor service. Some of the |
| | | services offered by these servers are remote updates for |
| | | those devices containing custom software and product |
| | | databases on-board as well as sending text messages to |
| | | devices. |
| 32 | Billing Servers | A cluster of servers responsible for capturing billable |
| | | events from other servers in the system, processing and |
| | | summarizing these events for the purpose of generating |
| | | invoices and transferring money to and from Proprietor |
| | | accounts via EFT (Electronic Funds Transfer)/ACH |
| | | (Automated Clearing House). |
| 33 | Payment Gateway Servers | A cluster of servers responsible for providing a uniform |
| | | interface to payment processors and payment gateways for |
| | | the purpose of authorizing credit, debit, check and smart- |
| | | card transactions. |
| 34 | Interactive Television | A television system as is typically found in modern hotels, |
| | | resorts and other related locations that allow customers to |
| | | access for example the following services: |
| | | On-Demand movies |
| | | Order room service |
| | | On-Demand Videogames |
| | | Extend stay/Check-out |
| | | These systems generally provide the user with a graphical |
| | | interface to allow them to navigate and select the desired |
| | | services. The ticketing system would be available as |
| | | another option on the system and once selected the |
| | | catalogue would be made available. The system could |
| | | also be used to direct advertisements related to products |
| | | available on the service. |
| 35 | Interactive Telephone | As IP-Phone technology becomes more mainstream |
| | | devices are being produced that provide additional |
| | | services such as video conferencing, access to email, web |
| | | browsing and the capability to access services in much the |
| | | same way as a Laptop, Cell Phone or mobile computing |
| | | device such as a PDA can do now. |
| | | The service will be made available on such devices and |
| | | operate much the same as it would on a mobile device or |
| | | Interactive TV. |

I claim:

1. A ticketing system comprising:
a computing facility operable to
receive an order, for goods and/or services of a provider, transmitted to the facility by a remote input device;
ascertain if the goods and/or services ordered are available from the provider in sufficient quantities to permit the order to be filled;
transmit to the remote input device, if goods and/or services availability has been ascertained to be insufficient to fill the order, a notification as to non-availability; and
if goods and/or services availability has been ascertained to be sufficient to fill the order, satisfy the order.

2. A system according to claim 1, wherein the goods and/or services are selected from: authorization for access to a facility, authorization for access to an event, a seat license to an event and a license for passage on a means of conveyance.

3. A system according to claim 1, wherein order satisfaction does not occur until payment for the order has been received.

4. A system according to claim 1, wherein
upon receipt of an order, the computing facility ascertains if the order is subject to inventory control or provider authorization; and
the computing facility deems that the goods and/or services ordered are available from the provider in sufficient quantities to permit the order to be filled if the order is not subject to inventory control or provider authorization.

5. A system according to claim 4, wherein
if the order has been ascertained to be subject to provider authorization, the computing facility ascertains availability by transmitting an order to the provider; and
if the order has been ascertained to be subject to inventory control but not subject to provider authorization, the computing facility ascertains availability by comparing the order against an inventory maintained by the computing facility.

6. A system according to claim 5, wherein availability is sufficient to fill the order, the order is subject to inventory control and is not subject to provider authorization, the inventory of the computing facility is adjusted following the comparison to reflect the order.

7. A system according to claim 6, wherein: the remote input device gathers payment information which is transmitted by the remote input device along with the order; after the computing facility has ascertained if availability is sufficient to permit the order to be filled, the payment information is utilized by the computing facility to attempt to secure payment for the order from a financial institution; and if the attempt to secure payment is unsuccessful:
the computing facility sends a change order to the provider to reverse the order if the order was subject to provider authorization; and
the inventory of the computing facility is adjusted to reverse the order if the order was subject to inventory control but not subject to provider authorization.

8. A system according to claim 1, wherein the remote input device is selected from a self-serve kiosk, an automated teller machine, a computer and a point of sale terminal, and tickets are generated by a printer coupled to the remote input device to evidence the satisfaction of the order.

9. A system according to claim 1, wherein the remote input device is selected from a PDA and a phone, and tickets to evidence the satisfaction of the order are generated by the computing facility and transmitted electronically to the remote input device.

10. A system according to claim 9, wherein the ticket transmitted to the input device is selected from:
a signal which the device can transmit wirelessly to a reader at the venue; and
a barcode which can be displayed on the screen of the device.

11. A system according to claim 1, wherein the computing facility is operable to export sales and transaction data in real-time to the providers.

12. A system according to claim 1, wherein the remote input device is selected from a PDA, a phone and a computer, and the remote input device communicates with the computing facility via a web browser.

13. A system according to claim 1, wherein the computing facility is adapted to receive information and updates from providers as to goods and/or services to be sold through the system through a secure Internet portal.

14. A system according to claim 13, wherein the remote input device is selected from a kiosk, a point of sale terminal and a computer, and the remote input device communicates with the computing facility via an application downloaded to the device.

15. A system according to claim 14, wherein the remote input device periodically communicates with the computing facility to receive updates to the application and updates as to the goods and/or services to be sold through the system.

16. A system according to claim 1, wherein the remote input device is an interactive television.

17. A system according to claim 1, wherein the computing facility is further adapted
to receive an access query transmitted to the computing facility by a remote authentication device;
to transmit to the remote authentication device an indication if the query corresponds to a previously-satisfied order.

18. A system according to claim 17, wherein the query transmitted by the authentication device is generated from a data field selected from:
a confirmation number;
a barcode printed on a ticket;
a barcode displayed on the screen of a wireless phone or a PDA; and
a wireless signal sent by a wireless phone or a PDA.

19. A system according to claim 17, wherein if an order is transmitted to the computing facility by a wireless telephone and satisfied, a query, in relation to the goods and/or services forming the subject of said order, transmitted by the authentication device and generated from the telephone number associated with said wireless telephone results in an indication that the query corresponds to said previously-satisfied order.

20. A system according to claim 17, wherein, if the payment information transmitted with a satisfied order comprises the number and expiry date of a credit card to be billed, a query in relation to the goods and/or services forming the subject of said order transmitted by the authentication device and generated from the credit card number results in an indication that the query corresponds to said previously-satisfied order.

21. A system according to claim 1, wherein the notification as to non-availability is transmitted along with an indication as to an alternative for the order that is available.

22. A system according to claim 1, further characterized in that the computer facility is adapted to receive orders from multiple remote input devices.

23. A system according to claim 22, wherein the computer facility is adapted to periodically communicate with and update the multiple remote input devices as to the goods and/or services, and the prices thereof, available to be sold through the system.

24. A system according to claim 23, wherein the computer facility is adapted to update the multiple remote input devices independently of one another and differentiate the product available thereon, and the cost of such product.
